(19) United States
(12) Patent Application Publication
(10) Pub. No.: US 2006/0182854 A1
(43) Pub. Date: Aug. 17, 2006

(54) Method for making a chocolate-coated pig skin product

(76) Inventor: Dora M. Albritton, Kinston, NC (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 11/059,807

(22) Filed: Feb. 17, 2005

(51) Int. Cl. A23L 1/00

(52) U.S. Cl. 426/303

(57) ABSTRACT

The present invention is addressed to a method for making a chocolate-coated pig skin product. The method commences by deep frying cured pig skins to form fried pig skins having a moisture content of between about 10 to about 15 percent. Next, the fried pig skins are tempered and coated with lukewarm chocolate to form chocolate-coated pig skins. Finally, the chocolate-coated pig skins are tempered to form a chocolate-coated pig skin product.

### CROSS-REFERENCE TO RELATED APPLICATIONS

None

### STATEMENT REGARDING FEDERALLY SPONSORED RESEARCH

Not applicable.

### BACKGROUND OF THE INVENTION

Pig skins originated as a by-product of the meat industry and have been manufactured and sold as a consumable product for many years. Generally, pig skins are formed by rendering bacon rinds at low temperature and then deep frying the rendered rinds at high temperature which causes them to puff up. The resulting product is a generally bite-sized, crunchy snack having a bacon flavor, which is referred to as a pig skin. Traditional methods for preparing the skins are described, for example, in U.S. Pat. Nos. 2,179,616 and 2,855,309.

The popularity of pig skins as a snack led to the development of various processes for making the skins crispier, more uniform in size and shape, etc. and for making the skins more efficiently or economically. For example, U.S. Pat. No. 2,855,309 discloses a method for reducing the number of rendered bacon rinds that do not puff, and thus are substantially inedible, by treating the rinds with acetic acid.

U.S. Pat. No. 2,947,635 discloses a method for establishing an internal pressure within the cellular structure of the expanded skin pieces to prevent collapse thereof during protein setting and residual moisture removal. Several procedures are outlined for establishing the needed internal pressure. One such procedure involves submersing the pig skin in an oil bath which is maintained in a vacuum system. Alternatively, the skins may be subjected to pressure when the skins are removed from the oil bath and returned to atmospheric conditions. The preferred procedure is to use a separate vacuum cooling step after the skins are removed from the oil bath. The desired moisture content at the time of popping is generally 4-7 percent. Moisture levels over 10 percent are considered not desirable from the standpoint of toughness, while levels less than 4 percent result in a charred taste in the final product.

U.S. Pat. No. 3,401,045 discloses a method for producing chips of uniform color, brittleness, and expansion characteristics, and have substantially uniform tenderness, crispness, and flavorable properties. These characteristics are achieved by rendering green pork rinds and then curing them in a liquid curing and flavoring medium and then drying the pieces to a hard and brittle state. The rinds are thereafter popped by frying in oil.

U.S. Pat. No. 3,725,084 discloses a method for treating puffable food pellets, such as green pig skins, by introducing and uniformly distributing moisture in the skins by forcing moisture into the spaces in the molecular structure of the protein or carbohydrate during a cooking cycle using steam under predetermined temperature and pressure conditions.

U.S. Pat. RE 33,174 discloses the processing of a rind into dehydrated granular form that is microbiologically stable for extended periods and can be rapidly rehydrated into a prepared ground rind.

U.S. Pat. No. 5,356,645 discloses a microwave pork skin. The product is prepared by steaming, then dehydrating in oil if necessary. These pig skins are prepared without the need for conventional high heat frying processes.

All of the processes described above are intended to produce a conventional pig skin product. As with all successful and popular foods, new products with unique appearances, tastes and textures continue to be sought.

### BRIEF SUMMARY OF THE INVENTION

The present invention is addressed to a method for making a chocolate-coated pig skin product. The method commences by deep frying cured pig skins to form fried pig skins having a moisture content of between about 10 to about 15 percent. Next, the fried pig skins are tempered and coated with lukewarm chocolate to form chocolate-coated pig skins. Finally, the chocolate-coated pig skins are tempered to form a chocolate-coated pig skin product.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a block diagram illustrating the stages of the inventive method.

### DETAILED DESCRIPTION OF THE INVENTION

Chocolate is made from the seeds of the tree Theobroma cacao. Theobroma is Greek for “food of the gods.” The Maya formed cacao into a drink as early as 400 B.C. The Aztec culture, dominant in Mesoamerica in the 14th Century, revered the cacao tree and used the beans to make a bitter drink called “xocoatl.” Explorer's brought the drink to Europe in the 16th Century. With the addition of sweetening, it became an expensive luxury. In the 17th Century, the advent of molding processes gave birth to solid chocolate.

Today, there is no doubt that chocolate has become an extremely popular delicacy. In 2001, the global confectionary market reached an estimated value of 73.2 billion. http://www.icco.org. US consumers eat 2.8 billion pounds of chocolate annually, representing nearly half of the world's supply, with the annual per capita consumption of chocolate being 12 pounds per person. Chocolate also is America's favorite flavor. A recent survey revealed that 52 percent of U.S. adults said they like chocolate flavor best. The second favorite flavor was a tie (at 12 percent each) between berry flavors and vanilla. U.S. chocolate manufacturers currently use 40 percent of the almonds produced in the United States and 25 percent of domestic peanuts. U.S. chocolate manufacturers also use about 3.5 million pounds of whole milk every day to make chocolate. These facts are contained in a survey conducted by the Chocolate Manufacturer's Association and posted on the National Confectioners Association website at http://www.candyusa.org.

To make chocolate, the cacao or cocoa, beans are harvested, cleaned, and shelled. Removing the shells leaves only the cocoa nibs, which undergo alkalization to develop the beans' flavor. The nibs are milled to create cocoa liquor, which consists of cocoa particles suspended in cocoa butter. The cocoa liquor is pressed to extract cocoa butter. The remaining mass is referred to as the cocoa presscake. The amount of extracted butter is controlled, enabling the manufacturer to produce presscake of varied fat levels. The presscake is used to produce cocoa powder. Together with cocoa liquor, the cocoa butter is used to produce chocolate. Additional ingredients, e.g., sugar, milk, etc., are added, and the mixture is refined and put through a conching process. Conching is a kneading or smoothing process. Finally, the mixture is tempered, put into molds, and cooled.

Chocolate is a complex and much varied foodstuff. Each stage of the chocolate-making process alters its chemistry and, thus, the resulting chocolate's texture and flavor. For example, manufacturer's alter the levels of cocoa butter to produce a variety of types of chocolate. For example, different types of chocolate include milk chocolate, dark chocolate, bittersweet chocolate, and couverture. Couverture has the greatest amount of added cocoa butter, followed by milk chocolate, and then dark chocolate. Bittersweet chocolate has the least amount of added cocoa butter. The more bitter chocolates generally are used in cooking and baking, while the more sweet chocolates generally are used for candies and other confectioneries.

The melting point of chocolate also is relevant. Chocolate's perceived texture is a function of the way in which the material melts and breaks up in the mouth. Chocolates having a melting point near 98.6° F. will cause the chocolate to melt in the mouth. If the melting point is too high, it will result in a waxy feel and will not melt entirely. If the melting point is too low, the product may not be stable during storage. Chocolate's shelf-life also is determined by the tempering process. Cocoa butter is polymorphic and has more than 6 crystal forms, only one of which has the necessary heat resistance and melting properties. Tempering prior to the chocolate's solidification ensures that only the stable crystals are formed during chocolate production.

Resulting chocolate may be molded and sold in any shape imaginable. For example, it is not uncommon to see chocolate sold in the shape of bars, hearts, rabbits, cars, etc. Chocolate may serve as a housing for fillings such as caramels, crèmes, and liquors. Chocolate also may be used as a coating for fruits, vegetables, legumes, nuts, insects, etc. For example, chocolate may serve as a coating for strawberries, cherries, bananas, raisins, peanuts, cashews, pecans, almonds, ants, and so on. Cocoa powder may be used in drinks, such as milk, coffee and what is generally referred to as hot chocolate.

Although chocolate has been used as a coating for a variety of foods, it has never been used as a coating for pig skins. The present invention is addressed to a method for chocolate-coating pig skins. In order to make a product with the desired organoleptic properties, all of the factors discussed above, including the chocolate's type, taste, texture, melting point, and storage, must be taken into account. The properties of the pig skin also must be taken into account to provide the sought-after final product. For example, relevant properties include the pig skin's fat content, water content, surface texture, etc. The coating process must be specifically tailored for the pig skin.

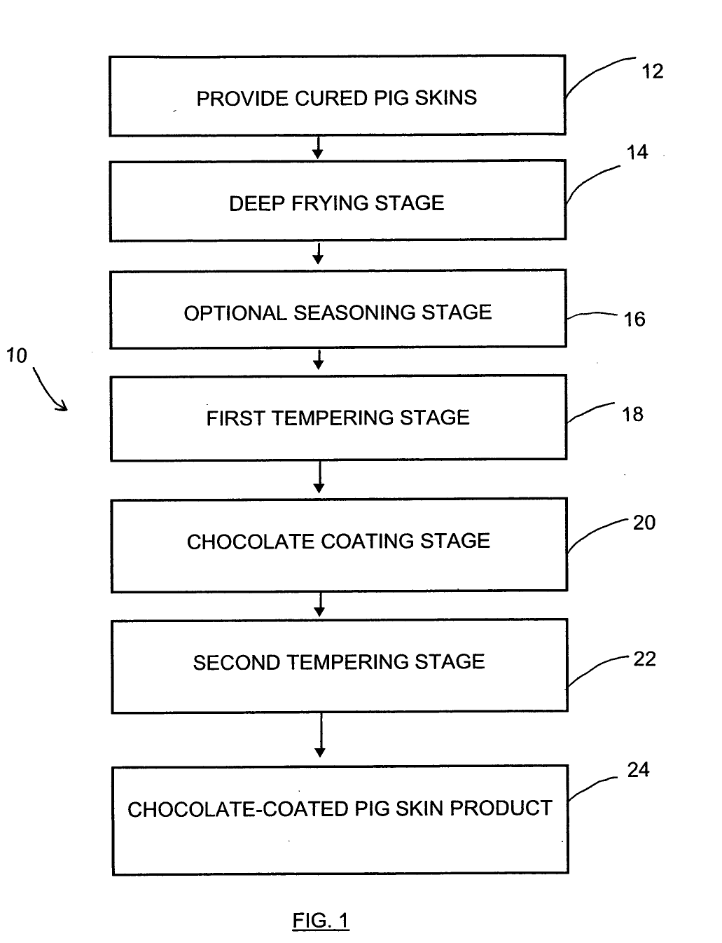

FIG. 1 sets forth, generally, the process, 10, for making chocolate-coated pig skins. As indicated by block 12, the first step is to provide cured pig skins. Such skins are commercially available, for example, from American Skin Company, Burgaw, N.C., and are rendered or cured in conventional fashion. The skins also may be treated, for example by smoking, to provide an additional, unique flavor to the final product.

The next stage or step in the process, as indicated at block 14, is to deep fry the cured pig skins. For best results, the cured pig skins can be stored at room temperature for up to 6 months prior to frying. The cured pig skins are deep fried for about 1 to 2 minutes in cooking oil maintained at about 350° F. to 400° F. Cooking the skins at a temperature below 350° F. will result in the skins being hard. If cooked above 400° F., the skins will burn. Any conventional cooking oil may be used, with the oil selected partially determining the organoleptic properties of the fried skins. For example, frying in peanut oil or olive oil gives the pig skins a light, less greasy taste. If a more oleaginous taste is desired, then a heavier cooking oil, such as lard may be used. The temperature of the cooking oil should be maintained during the cooking process and may be monitored with a cooking thermometer or gauge. When the skins have been sufficiently cooked, they will become “puffed” in texture and float to the surface of the cooking oil. The surface of the skin also will be a light brown. The moisture content of the skins should be no greater than 10 to 15 percent of the total weight. The fried skins should be bite-sized, i.e., meaning that the product should be able to fit in a person's mouth for consumption. The skins may be cooked, for example, in 6 lb batches.

After cooking, the pig skins are removed from the cooking oil, drained, and then optionally seasoned as indicated at block 16. For best results, the skins should be seasoned immediately after draining while they are still hot. This enables the skins to absorb and retain more seasoning. The seasoning to be applied will vary depending on the intended consumer's tastes. For example, to give the skins a barbeque flavor, the seasoning may include salt, season salt, paprika, black pepper, red pepper, chili pepper, and monosodium glutamate. Using this seasoning recipe, 1 to 1 and ½ cups of seasoning may be used for 55 lbs of cooked fried pig skins.

After seasoning, if seasoning is desired, the process proceeds to block 18 which indicates that the fried pig skins are put through a first tempering stage. This first tempering stage involves cooling the pig skins under conditions and for a time effective to achieve a chocolate accepting surface. A chocolate accepting surface is one which is adequate for a subsequently applied lukewarm chocolate to adhere to the surface and create a coating of sufficient thickness to obtain the desired organoleptic properties. This may mean cooling to achieve a uniform temperature throughout the skin. Alternatively, it may be preferred for the center of the skin to maintain a slightly elevated temperature in order to provide a slight heating of the applied chocolate. This slight heating may result in a further or additional softening of the chocolate after application, which will encourage the chocolate to uniformly coat the surface of the pig skin and eliminate any discontinuities. Where complete cooling is desired, for example, the skins have been laid out in a stainless steel pan and left to cool for an hour. An electric fan may be used to speed up the cooling process.

The selected chocolate is heated to a lukewarm temperature and applied to the fried pig skins. For present purposes, lukewarm means moderately warm, e.g., between about 150° F. to about 175° F. At this temperature, the chocolate will adhere to the surface of the pig skin and maintain its texture and taste. If not applied lukewarm, the chocolate may spread too thin and cool to soon. Additionally, when the chocolate is applied lukewarm, the seasoning maintains its distinctive characteristics. The lukewarm chocolate is applied to the pig skins, for example, by pouring, dipping, or like procedure. Standard food grade emulsifiers can be used in the chocolate coating in conventional fashion to achieve special effects as is necessary, desired or convenient.

Because the inventive method is flexible as to the amount of chocolate applied, a manufacturer can easily produce variations dictated by cost and consumer taste. Consumer taste panels can be used to determined consumers' organoleptic preferences. For example, the balancing of consumers' desire for experiencing a more chocolate or more pig skin flavored-product will in part dictate the amount of chocolate applied. For consumers who prefer a heavier chocolate taste, a greater amount of chocolate may be applied to the skins. For consumers who prefer a heavier pig skin flavor, less chocolate may be applied. The amount of chocolate applied also may depend on whether the desired coating is continuous or discontinuous, both being incorporated within the invention. For consumers desiring a less chocolaty taste, the coating may be applied on only a portion of the outer surface of the skin as opposed to completely encapsulating the pig skin.

As one example, the chocolate used has been Gurley's Golden Recipe almond bark. The chocolate was brought to a lukewarm temperature using a standard double boiler. Before applying the chocolate to the skins, additional vanilla flavoring was added to the almond bark chocolate. Any other conventional or unconventional flavorings may be added to alter the taste of the final product. While at a lukewarm temperature, the chocolate mixture was poured over the pig skins.

After the pig skins have been chocolate-coated, a second tempering stage commences, as indicated at block 22. This second tempering stage involves cooling the chocolate covered skins under conditions and for a time such that the chocolate adheres to the surface of the pig skin, hardens and forms a continuous or discontinuous coating of desired thickness. This second tempering stage also prevents moisture build-up, which will alter the texture and taste of the final product. As an example of the second tempering stage, the skins may be laid out in a stainless steel pan under normal atmospheric conditions and left to cool for 1 to 2 hours. That time can be reduced by fan-cooling the skins as described above in connection with the first tempering stage. The result is chocolate-coated pig skin product as indicated at block 24.

Once the chocolate-coated skins have been cooled, they may be immediately consumed or packaged for storage. If stored in air-tight containers, the skins will maintain their taste and texture for up to 6 months. Refrigerating the product in the air-tight containers will preserve the skins for up to a year.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

I claim

1. A method for making chocolate-coated pig skin product, comprising the steps of:
(a) deep frying cured pig skins to form fried pig skins having a moisture content of between about 10 to about 15 percent;
(b) tempering said fried pig skins;
(c) coating said tempered pig skins with lukewarm chocolate to form chocolate-coated pig skins; and
(d) tempering said chocolate-coated pig skins to form a chocolate-coated pig skin product.

2. The method of claim 1, further comprising the step of:
(e) spicing said deep fried pig skins after said step (a) and prior to said step (b).

3. The method of claim 1, wherein one or more of said steps (b) and (c) of tempering are enhanced by a high speed fan.

4. The method of claim 1, wherein said cured pig skins are smoked.

5. The method of claim 1, wherein said chocolate further comprises vanilla flavoring.

6. The method of claim 1, wherein said step (c) further comprises heating said chocolate to between about 150° F. to about 175° F.

7. The method of claim 1, wherein said step (a) further comprises deep frying said cured pig skins in cooking oil heated to between about 350° F. to 400° F.

8. The method of claim 1, wherein said step (c) comprises hand dipping said fried pig skins in said lukewarm chocolate.

9. The method of claim 1, wherein said step (c) further comprises pouring said lukewarm chocolate over said fried pig skins.

10. The method of claim 1,wherein said chocolate-coated pig skins have a continuous chocolate coating.

11. The method of claim 1,wherein said chocolate-coated pig skins have a discontinuous chocolate coating.

12. A method for making chocolate-coated pig skin product, comprising the steps of:
(a) deep frying cured pig skins in cooking oil having a temperature of 350° F. to 400° F. for between about 1 to 2 minutes to form fried pig skins having a moisture content of between about 10 to about 15 percent;
(b) spicing said deep fried pig skins;
(c) tempering said fried pig skins by cooling said fried pig skins for about 1 hour at room temperature;
(d) coating said tempered pig skins with chocolate heated to between about 150° F. to about 175° F. to form chocolate-coated pig skins; and
(e) tempering said chocolate-coated pig skins by cooling said chocolate-coated pig skins for between about 1 to 2 hours at room temperature to form a chocolate-coated pig skin product.

13. The method of claim 12 wherein said cooking oil of step (a) comprises peanut oil.
